(19) United States
(12) Patent Application Publication
(10) Pub. No.: US 2003/0084176 A1
(43) Pub. Date: May 1, 2003

(54) System and method for discovering devices in a video network

(75) Inventors: Jayanta Tewari, Austin, TX (US); Nainesh B. Desai, Cedar Park, TX (US)

Correspondence Address: Michael R. Barre, Baker Botts L.L.P., Suite 600, 2001 Ross Avenue, Dallas, TX, 75201-2980, US

(73) Assignee: VTEL Corporation, Austin, TX

(21) Appl. No.: 10/021,771

(22) Filed: Oct. 30, 2001

(51) Int. Cl. G06F 15/16

(52) U.S. Cl. 709/230; 709/227

(57) ABSTRACT

In a system for discovering devices in a video network, a network management system (NMS) determines whether a video device in the video network supports a first network protocol, such as SNMP. If the device supports the first protocol, the NMS automatically uses the first protocol to retrieve attributes of the device from the device. If the device does not support the first protocol, the NMS automatically determines whether the device supports a second protocol, such as HTTP. If the device supports the second protocol, the NMS automatically uses the second protocol to retrieve the attributes of the device. In an example embodiment, if the device does not support the second protocol, the NMS may test for support of additional protocols, such as Telnet or VT-100. If one of those protocols is supported, the NMS may automatically use that protocol to retrieve the attributes of the device.

### TECHNICAL FIELD OF THE INVENTION

This invention relates in general to video network communications. In particular, the invention relates to a system and method for discovering devices in a video network.

### BACKGROUND OF THE INVENTION

Video conference calls have grown in popularity as the expense of video conferencing devices has decreased and the availability of broadband communication networks has increased. Businesses often prefer the more personal communication available through video conferences, compared with telephone conferences, and also enjoy savings in travel costs while still having a personal presence among the participants that is not possible with audio only communications. The increased popularity of video conferencing has resulted in the deployment of video network devices in wide ranging disparate locations, with the devices interfaced by business networks and/or public networks.

Often, video calls involve the interfacing of various types of video network devices manufactured by a variety of different manufacturers and using a variety of protocols and network communications interfaces. For instance, a single video network might include Internet Protocol (IP) phones, video endpoints, multi-point control units (MCUs), gateways, and gatekeepers manufactured by different manufacturers. The different devices may also use different network protocols. For example, a video network might include one endpoint that communicates using the Simple Network Management Protocol (SNMP), another endpoint that communicates using the Hypertext Transfer Protocol (HTTP), an MCU that communicates using the Telnet protocol, and a gateway that communicates using the VT-100 terminal emulation standard. Furthermore, even if two devices use the same network protocol, they may nevertheless use different messaging techniques within that network protocol. For example, an endpoint manufactured by VTEL and an endpoint manufactured by ACME may both send pages of information using HTTP, but each may provide different kinds of content and different arrangements of content within the pages.

A typical video network also includes a network management station (NMS) which is used to administer the video network. The NMS, which may also be known as an administrative workstation, is used to store information describing the configuration of the video network. The configuration preferably identifies which types of devices are present and provides operating characteristics for those devices. However, when a video network includes devices that use different network protocols and/or different messaging techniques or program interfaces within those protocols, obtaining an accurate description of the configuration can be a difficult task. In a hypothetical conventional video network, an ACME NMS can usually determine which types of ACME devices (e.g., endpoints, MCUs, etc.) are in the network, but if devices from other manufacturers are also present, the NMS cannot determine the types of those other devices. Consequently, the configuration in the NMS will either contain only an incomplete list of the devices on the network, or the information for the other devices will have to be entered manually.

As recognized by the present invention, a need therefore exists for a better way for NMSs to determine network configurations in heterogeneous video networks, such as those containing devices from different manufacturers and/or devices which use different network protocols. For instance, it would be beneficial to provide an NMS that can automatically obtain configuration information from video devices that use different network protocols. It would also be beneficial to provide an NMS that can automatically obtain configuration information from video devices that use different messaging techniques or program interfaces within a common network protocol.

### SUMMARY OF THE INVENTION

The present invention involves a method, a system, and a program product for discovering devices in a video network. In a system according to the invention, an NMS determines whether a video device in the video network supports a first network protocol, such as SNMP. If the device supports the first protocol, the NMS automatically uses the first protocol to retrieve attributes of the device from the device. If the device does not support the first protocol, the NMS automatically determines whether the device supports a second protocol, such as HTTP. If the device supports the second protocol, the NMS automatically uses the second protocol to retrieve the attributes of the video device. In an example embodiment, if the device does not support the second protocol, the NMS tests for support of additional protocols, such as Telnet or VT-100. If one of those protocols is supported, the NMS automatically uses the supported protocol to retrieve the attributes of the device. The NMS may then repeat one or more of the above operations to identify any additional devices in the video network.

The present invention thus provides for automatic identification of different types of devices (e.g., endpoints, MCUs, etc.) that use different network protocols in a video network. The invention therefore reduces or eliminates unidentified devices in the configuration maintained by the NMS, and reduces or eliminates the need for a network administrator to manual identify devices in the video network. Additional technical advantages provided by various embodiments of the invention will become apparent upon review of the following material, which includes a detailed description of an example embodiment of the invention.

### BRIEF DESCRIPTION OF THE DRAWINGS

Additional features, functions, and technical advantages will become apparent upon review of the following description, claims, and figures, in which:

FIG. 1 presents a block diagram of an example embodiment of a video network;

FIG. 2 depicts an example configuration table identifying attributes of devices in the video network of FIG. 1;

FIGS. 3A and 3B present a flowchart of an example embodiment of a method for discovering devices in a video network;

FIG. 4 presents a block diagram of an example process for discovering devices in a video network; and

FIG. 5 presents a block diagram of the NMS of FIG. 1.

### DETAILED DESCRIPTION

Referring now to FIG. 1, an example embodiment of a video network 10 includes a subnet 12A, a subnet 12B, and a network management station (NMS) 20 which communicates with subnets 12A and 12B via an administrative connection 22. Subnet 12A includes two endpoints 14A and 14B and a multi-point control unit (MCU) 16A. Endpoints 14A and 14B each include a camera for capturing video images, a microphone for capturing audio, and output devices such as video displays and speakers for presenting output such as video and audio captured from a remote source. When subnet 12A is hosting a multi-point video call, MCU 16A receives input from endpoints 14A and 14B for transmission to the remote location, and MCU 16A receives audio and video data from the remote location and forwards that data to endpoints 14A and 14B. Similarly, subnet 12B includes an MCU 16B, as well as three endpoints 14C, 14D, and 14E, and subnet 12B operates in a manner generally similar to subnet 12A. In ISDN subnets, the video devices may include buddy boxes that facilitate communications with NMS 20. In IP subnets, the video devices may include a gatekeeper 15 that manages the conferencing functionalities.

In the example embodiment, subnets 12A and 12B use different communications standards, and gateway 18 serves as a bridge between subnets 12A and 12B, converting data between the different standards as necessary to support intercommunication. Specifically, the equipment within subnet 12A communicates using the International Telecommunication Union (ITU) Telecommunications Standardization Sector (TSS) H.320 standards for videoconferencing over circuit-switched networks, such as Integrated Services Digital Network (ISDN) or switched 5G. By contrast, the equipment in subnet 12B communicates using the ITU-TSS H.323 standards for videoconferencing and multimedia communications over packet-switched networks, such as Ethernet and Token-Ring local area networks (LANs).

Furthermore, within each subnet, many of the devices were manufactured by different vendors and utilize different network protocols, different messaging techniques, and/or different physical communications interfaces. For instance, in video network 10, endpoint 14A was manufactured by VTEL and supports SNMP, but endpoint 14B was manufactured by ACME and supports Telnet, while MCU 16A supports HTTP. The other devices may support different protocols, such as VT-100. The devices in subnet 12B may also use a variety of different network protocols.

Furthermore, even if two devices use the same network protocol, they may nevertheless use different messaging techniques or program interfaces within that network protocol. For example, an endpoint manufactured by VTEL and an endpoint manufactured by ACME may both send pages of information using HTTP, but each may provide different kinds of content and different arrangements of content within the pages. Information about which devices are present and which network protocols and messaging techniques are used by those devices is typically required before video network 10 can be configured to carry a specific video conference call.

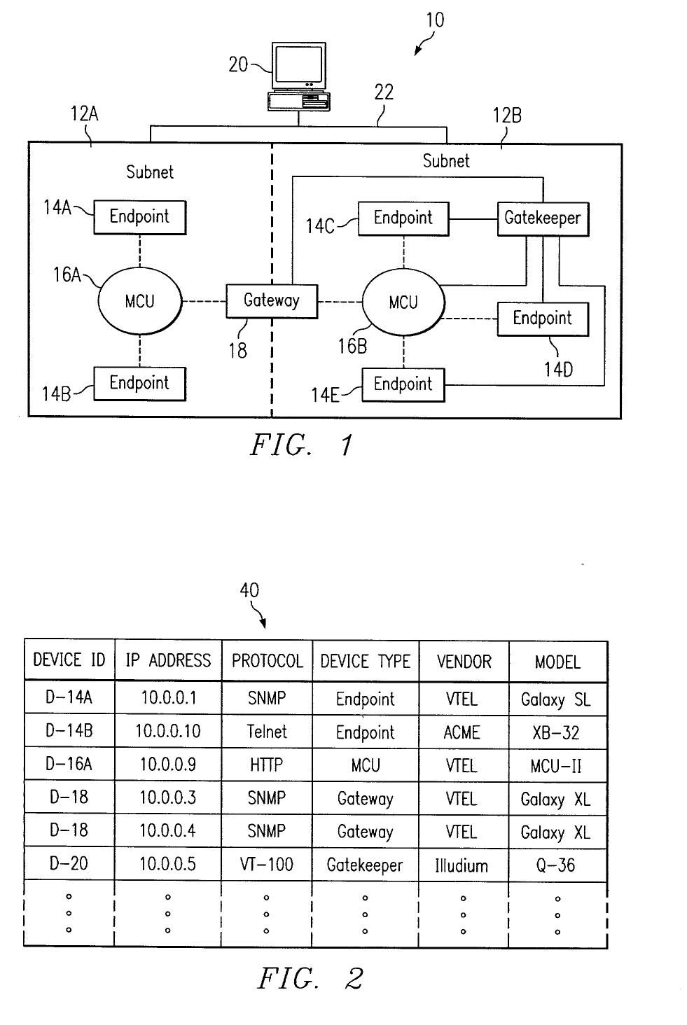

With reference now to FIG. 2, in accordance with the present invention, NMS 20 stores configuration information for use in operating video network 10. That configuration information, which may be stored in a configuration table 40, includes data that identifies network characteristics, such as which devices are in video network 10 and which network protocol each device uses.

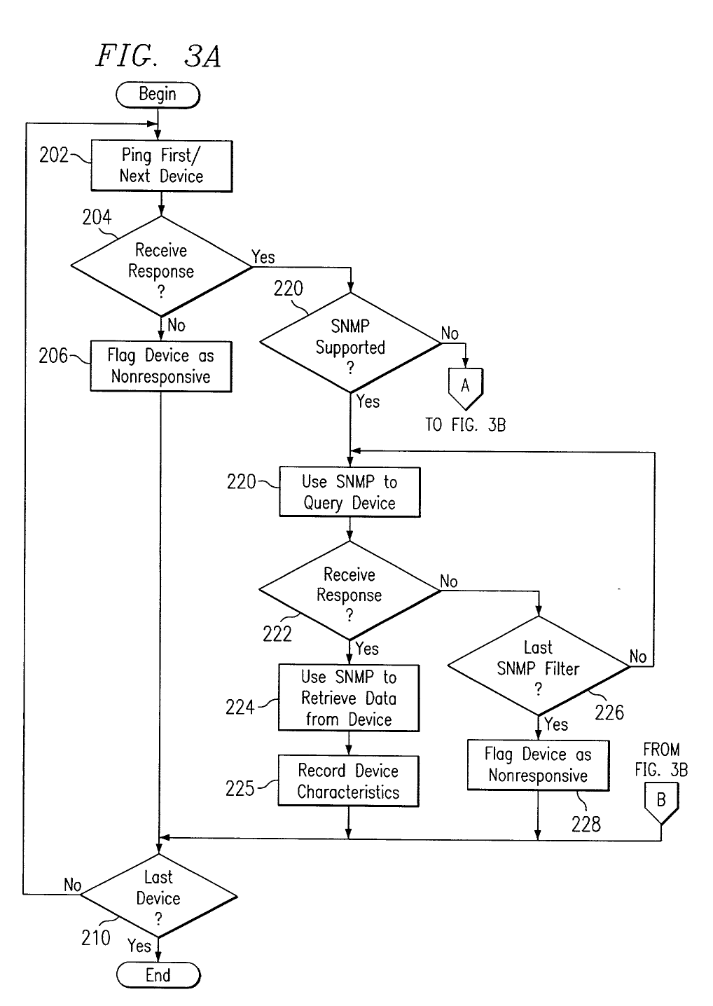

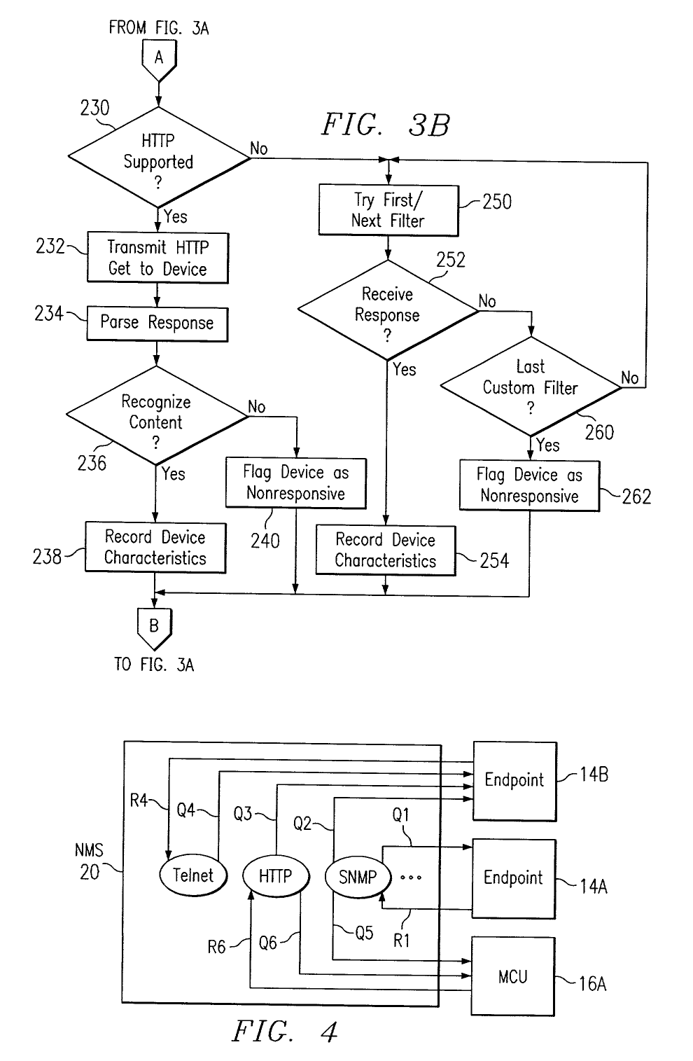

Referring now to FIGS. 3A and 3B, there is shown an example process according to the invention for automatically identifying the devices within video network 10, for example to populate a configuration table like configuration table 40. The process begins when NMS 20 is started, and NMS 20 periodically repeats the process to recognize configuration changes, such as changes to a device or the addition or removal of a device from video network 10. As depicted at block 202, an initial operation in the process is to ping a device in video network, by reference to a list of network addresses, such as Internet Protocol (IP) addresses, corresponding to the devices in video network 10. For example, when the devices in video network 10 were initially connected together, each device may have registered an IP address with NMS 20. As shown at block 204, NMS 20 then determines whether the selected device has responded to the ping. If no response has been received after the expiration of a predetermined time period and/or after a predetermined number of retries, NMS 20 flags the device an nonresponsive, as indicated at block 206. NMS 20 then determines whether any devices remain to be polled, as shown at block 210. If all of the devices in video network 10 have been polled, the process ends. Otherwise, the process returns to block 202, and NMS 20 selects another device to poll and pings that next device.

Referring again to block 204, when a device responds to the ping, NMS 20 then determines whether that device supports SNMP, as indicate at block 220. For example, NMS 20 may decide that the device supports SNMP if the device uses IP port 161 or 162 to communicate with software in NMS 20. If the device does not support SNMP, the process passes through page connector A, and NMS 20 tests for support of other network protocols, as described below.

However, if the device supports SNMP, NMS 20 uses SNMP to transmit a query (e.g., an SNMP GET) to the device, as depicted at block 220. As shown at blocks 222 and 224, if the device responds to the SNMP query, NMS 20 uses SNMP to obtain device attributes such as device type, vendor, and model, from the device. For instance, NMS 20 may use an SNMP filter to retrieve some or all of the pertinent attributes of the device from an SNMP agent running on the device. The SNMP filter may be an identifier for a standard or public management information base (MIB). As shown at block 225, after obtaining the device attributes, NMS 20 updates configuration table 40 with the information learned about the device. For example, as indicated in the first row of configuration table 40, NMS 20 may obtain and store information which indicates that endpoint 14A has a protocol of SNMP, a device type of endpoint, a vendor of VTEL, and a model of Galaxy SL. The process then passes to block 210, which shows NMS 20 determining whether there are any more devices to poll. If so, the process returns to block 202 with NMS 20 pinging another device, and if not, the process ends, as described above.

However, referring again to block 222, if the device does not respond to the query, NMS 20 determines whether there are any more SNMP filters to try, such as identifiers for private MIBs, as indicated at block 226. For example, NMS 20 may maintain a group of identifiers for private MIBs for various vendors and for various types and models of equipment. If NMS 20 has not yet tried all of those filters, the process returns to block 220 with NMS 20 using one of the untried SNMP filters in an attempt to retrieve information from the device. The process then continues as described above until NMS 20 has obtained all of the pertinent attributes or has tried the last SNMP filter. NMS 20 is thus able to retrieve attributes from devices that use various different messaging techniques within SNMP. However, if the device does not respond to any of the SNMP filters, NMS 20 flags the device as nonresponsive, as depicted at block 228. The process then returns to block 210 and NMS 20 determines whether video network 10 includes any additional devices to poll, as described above.

With reference again to block 220, if NMS 20 determines that the device does not support SNMP, NMS 20 determines whether the device supports a second network protocol. As shown at block 230, in the example embodiment, the second protocol tried is HTTP. For instance, NMS 20 may determine that the device supports HTTP if the device uses IP port 80 to communicate with NMS 20. If the device supports HTTP, NMS 20 uses HTTP to transmit a request such as an HTTP GET to the device, as depicted at block 232, and parses the response, as shown at block 234. For example, the response may be a page or stream of data, and NMS 20 may search the data for particular text strings or sequences of data known to be associated with different vendors. Once a vendor is identified, NMS 20 may use a known messaging technique, such as a known, vendor-specific arrangement of data within pages, to extract data about the device. As indicated at blocks 236 and 238, if the vendor and data are recognized, NMS 20 records the device attributes in configuration table 40. If NMS 20 is unable to interpret the page, NMS 20 flags the device as nonresponsive, as shown at block 240. As indicated by page connector B, after the attributes have been recorded or the device has been flagged as nonresponsive in configuration table 40, the process returns to block 210, and NMS 20 determines whether any devices remain to poll, as described above.

Referring again to block 230, if NMS 20 determines that the device does not support HTTP, one or more additional protocols are tried, as indicated beginning at block 250. Specifically, in the example embodiment, NMS 20 maintains a list of custom filters to try on devices that do not support SNMP or HTTP. The custom filters may include queries that use terminal emulation protocols, such as Telnet and VT-100, or other vendor-specific network protocols. After transmitting a query with one of the custom filters, if a response is received, NMS 20 extracts device attributes from the response and records the device attributes in configuration table 40, as indicated at blocks 252 and 254. However, if the device does not respond to the first custom filter, NMS 20 tries one or more additional custom filters, as indicated at blocks 260 and 250. If NMS 20 has been unable to obtain the device attributes after trying all of the custom filters, NMS 20 flags the device as nonresponsive, as depicted at block 262. As indicated by page connector B, after NMS 20 has recorded the device attributes or flagged the device as nonresponsive, the process returns to block 210 with NMS 20 determining whether any devices remain to poll.

The above steps are then repeated, with NMS 20 attempting to automatically retrieve attributes from each device in video network 10. Thus, NMS 20 automatically retrieves device attributes from video devices with different types and models, with different vendors, with different network protocols, and with different custom or proprietary messaging techniques.

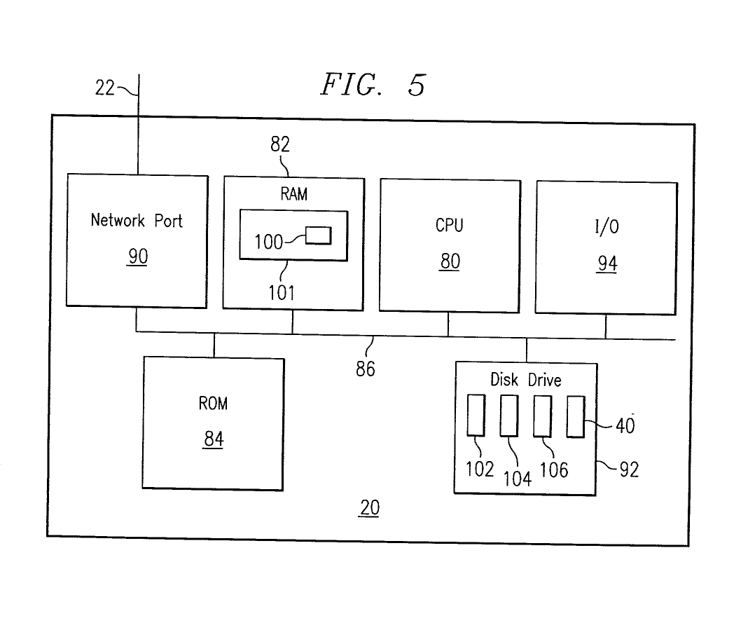

FIG. 4 presents an alternate representation of the process of looping through different network protocols to obtain attributes from devices in video network 10. As indicated by the arrow labeled Q1, NMS 20 uses SNMP to query endpoint 14A, and, as indicated by arrow R1, endpoint 14A responds to that query. NMS 20 therefore classifies endpoint 14A as an SNMP endpoint. Endpoint 14B, however, does not respond to an SNMP query Q2 or an HTTP query Q3, but endpoint 14B does respond to a Telnet query Q4, as indicated by arrow R4. NMS 20 therefore classifies endpoint 14B as a Telnet endpoint. Similarly, MCU 16A does not respond to an SNMP query Q5, but does send a response R6 in reply to an HTTP query Q6. MCU 16A is therefore classified as an HTTP MCU.

Referring now to FIG. 5, NMS 20 includes hardware and software for managing video network 10. NMS 20 may be a data processing system that has been designed specifically to serve as a video network manager, a personal computer, or any other suitable device. In the example embodiment, NMS 20 includes random access memory (RAM) 82, one or more central processing units (CPUs) 80, ROM 84, one or more disk drives 92, and/or other types of nonvolatile memory. Additional components include a network port 90 for communicating with external devices, such as the equipment in subnets 12A and 12B, as well as various input and output (I/O) devices 94, such as a keyboard, a mouse, and a video display. One or more buses 86 carry communications between the various hardware components.

The software in NMS 20 includes a device-discovery module 100, which may be part of a video network manager 101. NMS 20 may store device-discovery module 100 locally in nonvolatile memory and may load some or all of device-discovery module 100 into RAM 82 in preparation for execution. When executed, device-discovery module 100 causes NMS 20 to perform the operations described above with reference to FIGS. 3A and 3B. In addition, the various SNMP filters 102, HTTP filters 104, and custom filters 106 described above may be stored on disk drive 92. Configuration table 40 may also be stored on disk drive 92. Alternatively, some or all of the computer instructions and/or data for device-discovery module 100 may be stored remotely and retrieved as needed, for example from a LAN, a wide area network (WAN), the Internet, etc. NMS 20 may be located at a customer site with some or all of the video devices or located remotely, for example at the location of a video network service provider.

The various components nevertheless cooperate to form a video network that can automatically discover video devices in the network, even though the network may include many different types of devices and those devices might come from different vendors and might use different network protocols and/or messaging techniques. The example embodiment thus facilitates operation of heterogeneous video networks and reduces or eliminates the need for manual intervention when building constructs such as network configuration tables.

Although an example embodiment has been described in detail, those of ordinary skill in the art will understand that many details may be changed in alternative embodiments without departing from the scope and spirit if the invention. For example, the present invention may be implemented in numerous different hardware environments. Data processing systems incorporating the invention may include, without limitation, personal computers, mini computers, mainframe computers, and distributed computing systems. Furthermore, the modules and components depicted within NMS 20 in the example embodiment represent functional elements that are reasonably self-contained so that each can be designed, constructed, or updated substantially independently of the others. In alternative embodiments, however, it should be understood that the components may be implemented as hardware, software, or combinations of hardware and software for providing the functionality described and illustrated herein.

Alternative embodiments of the invention also include computer-usable media encoding logic such as computer instructions for performing the operations of the invention. Such computer-usable media may include, without limitation, storage media such as floppy disks, hard disks, CD-ROMs, read-only memory, and random access memory; as well as communications media such wires, optical fibers, microwaves, radio waves, and other electromagnetic and/or optical carriers.

The scope of the invention is therefore not limited to the particulars of the illustrated embodiments or implementations but is defined by the appended claims.

What is claimed is:

1. A method of discovering video devices in a video network, the method comprising:
determining whether a video device in the video network supports a first network protocol;
in response to determining that the video device supports the first network protocol, automatically using the first network protocol to retrieve attributes of the video device from the video device;
in response to determining that the video device does not support the first network protocol, automatically determining whether the video device supports a second network protocol; and
in response to determining that the video device supports the second network protocol, automatically using the second network protocol to retrieve the attributes of the video device from the video device.

2. The method of claim 1, wherein:
the first network protocol comprises a Simple Network Management Protocol (SNMP); and
the second network protocol comprises a Hypertext Transfer Protocol (HTTP).

3. The method of claim 1, further comprising:
in response to determining that the video device does not support the second network protocol, automatically determining whether the video device supports one or more other network protocols; and
in response to determining that the video device supports another network protocol, automatically using that supported network protocol to retrieve the attributes of the video device from the video device.

4. The method of claim 3, wherein:
the first network protocol comprises a Simple Network Management Protocol (SNMP);
the second network protocol comprises a Hypertext Transfer Protocol (HTTP); and
the one or more other network protocols comprise a terminal emulation protocol.

5. The method of claim 4, wherein:
the one or more other network protocols comprise a Telnet protocol; and
the operation of automatically using the supported network protocol to retrieve the attributes of the video device comprises:
using the Telnet protocol to logon to the device and submit commands to the device; and
determining the attributes of the video device by reference to command responses from the video device.

6. The method of claim 4, wherein the one or more other network protocols comprise a VT-100 protocol.

7. The method of claim 1, wherein:
the operation of automatically using the first network protocol to retrieve the attributes of the video device comprises using a Simple Network Management Protocol (SNMP) to retrieve information from an agent of the video device; and
the operation of automatically using the second network protocol to retrieve the attributes of the video device comprises:
using a Hypertext Transfer Protocol (HTTP) to retrieve a page from the video device; and
determining the attributes of the video device by reference to the page.

8. The method of claim 1, further comprising transmitting a sequence of queries to the video device to identify a messaging technique for obtaining the attributes of the video device, wherein the sequence of queries includes a first query adapted to communicate with equipment from a first vendor and a second query adapted to communicate with equipment from a second vendor.

9. The method of claim 1, further comprising, in response to retrieving the attributes of the video device, repeating one or more of the operations for determining a supported network protocol to retrieve attributes of additional video devices.

10. A network management system (NMS) that automatically discovers video devices in a video network, the NMS comprising:
a communications interface in communication with the video devices;
memory that encodes computer instructions; and
a processor in communication with the communications interface and the memory, wherein the computer instructions, when executed by the processor, cause the NMS to perform operations comprising:
determining whether a video device in the video network supports a first network protocol;
in response to determining that the video device supports the first network protocol, automatically using the first network protocol to retrieve attributes of the video device from the video device;
in response to determining that the video device does not support the first network protocol, automatically determining whether the video device supports a second network protocol; and
in response to determining that the video device supports the second network protocol, automatically using the second network protocol to retrieve the attributes of the video device from the video device.

11. A video network comprising:
an NMS according to claim 10;
a first endpoint in communication with the NMS, wherein the first endpoint supports the first network protocol and the NMS automatically uses the first network protocol to retrieve device attributes from the first endpoint; and
a second endpoint in communication with the NMS, wherein the second endpoint supports the second network protocol and the NMS automatically uses the second network protocol to retrieve device attributes from the second endpoint.

12. A program product for discovering video devices in a video network, the program product comprising:
a computer-usable medium; and
computer instructions encoded in the computer-usable medium, wherein the computer instructions, when executed, cause a data processing system to perform operations comprising:
determining whether a video device in a video network supports a first network protocol;
in response to determining that the video device supports the first network protocol, automatically using the first network protocol to retrieve attributes of the video device from the video device;
in response to determining that the video device does not support the first network protocol, automatically determining whether the video device supports a second network protocol; and
in response to determining that the video device supports the second network protocol, automatically using the second network protocol to retrieve the attributes of the video device from the video device.

13. The program product of claim 12, wherein:
the first network protocol comprises a Simple Network Management Protocol (SNMP); and
the second network protocol comprises a Hypertext Transfer Protocol (HTTP).

14. The program product of claim 12, wherein the computer instructions cause the data processing system to perform further operations comprising:
in response to determining that the video device does not support the second network protocol, automatically determining whether the video device supports one or more other network protocols; and
in response to determining that the video device supports another network protocol, automatically using that supported network protocol to retrieve the attributes of the video device from the video device.

15. The program product of claim 14, wherein:
the first network protocol comprises a Simple Network Management Protocol (SNMP);
the second network protocol comprises a Hypertext Transfer Protocol (HTTP); and
the one or more other network protocols comprise a terminal emulation protocol.

16. The program product of claim 15, wherein:
the one or more other network protocols comprise a Telnet protocol; and
the operation of automatically using the supported network protocol to retrieve the attributes of the video device comprises:
using the Telnet protocol to logon to the device and submit commands to the device; and
determining the attributes of the video device by reference to command responses from the video device.

17. The program product of claim 15, wherein the one or more other network protocols comprise a VT-100 protocol.

18. The program product of claim 12, wherein:
the operation of automatically using the first network protocol to retrieve the attributes of the video device comprises using a Simple Network Management Protocol (SNMP) to retrieve information from an agent of the video device; and
the operation of automatically using the second network protocol to retrieve the attributes of the video device comprises:
using a Hypertext Transfer Protocol (HTTP) to retrieve a page from the video device; and
determining the attributes of the video device by reference to the page.

19. The program product of claim 12, wherein the computer instructions cause the data processing system to perform further operations comprising:
transmitting a sequence of queries to the video device to identify a messaging technique for obtaining the attributes of the video device, wherein the sequence of queries includes a first query adapted to communicate with equipment from a first vendor and a second query adapted to communicate with equipment from a second vendor.

20. The program product of claim 12, wherein the computer instructions cause the data processing system to perform further operations comprising:
in response to retrieving the attributes of the video device, repeating one or more of the operations for determining a supported network protocol to retrieve attributes of additional video devices.
